(19) United States
(12) Patent Application Publication
(10) Pub. No.: US 2014/0376999 A1
(43) Pub. Date: Dec. 25, 2014

(54) EXPANSION CARD MOUNTING ASSEMBLY

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventor: ZHAN-YANG LI, Shenzhen (CN)

(21) Appl. No.: 14/311,583

(22) Filed: Jun. 23, 2014

(30) Foreign Application Priority Data
Jun. 24, 2013 (CN) 2013102523729

(51) Int. Cl. G06F 1/18

(52) U.S. Cl. CPC G06F 1/186
USPC 403/374.5

(57) ABSTRACT

An expansion card mounting assembly includes a slot cover mounted on an expansion card, a mounting wall, a pressing member pivotably mounted on the mounting wall, and a sliding member slidably mounted on the mounting wall. The slot cover includes a bent portion. The mounting wall defines an expansion slot and a receiving slot and includes a support piece. The slot cover covers the slot with the bent portion located on the support piece. The pressing member includes a guiding piece aligned to the receiving slot. The sliding member can move on the mounting wall to shield the receiving slot and block the guiding piece to maintain the pressing member pressing the bent portion, or to be misaligned with the receiving slot to allow the guiding piece to move in the receiving slot to release the bent portion.

### CROSS-REFERENCE TO RELATED APPLICATIONS

This application claims all benefits accruing under 35 U.S.C. §119 from Chinese Patent Application No. 201310252372.9, filed on Jun. 24, 2013 in the China Intellectual Property Office. The contents of the Chinese Application are hereby incorporated by reference.

### FIELD

The present disclosure relates to mounting assemblies, and more particularly to a mounting assembly that can readily and firmly secure an expansion card in a computer chassis.

### BACKGROUND

Currently, many computer systems and other electronic devices employ circuit cards, such as expansion cards, adapters, and PC boards. These cards or boards are typically mounted perpendicularly to a computer motherboard. In particular, the cards are usually inserted into edge card connectors mounted on the computer motherboard. However, merely inserting a card into an edge card connector is usually insufficient to securely maintain the card within the computer chassis. Cards connected in this fashion can easily disconnect from the edge connector and be prevented or significantly inhibited from operating acceptably. Accordingly, an additional structure is used to secure a card within a computer chassis. A conventional manner of securing a card within a computer chassis is to provide a card bracket fastened to the computer chassis with a removable screw. Specifically, each mounting bracket is normally disposed across a card slot defined in the computer chassis and may include an aperture through which the fastener may pass.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric, exploded view of an embodiment of an expansion card mounting assembly.

FIG. 2 is similar to FIG. 1, but viewed from another angle.

FIG. 3 is an isometric view of a pressing member of the expansion card mounting assembly of FIG. 1.

FIG. 4 is an assembled view of the expansion card mounting assembly of FIG. 1 in a mounting position.

FIG. 5 is similar to FIG. 4, but viewed from another angle.

FIG. 6 is an assembled view of the expansion card mounting assembly of FIG. 1 in a released position.

FIG. 7 is similar to FIG. 6, but viewed from another angle.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

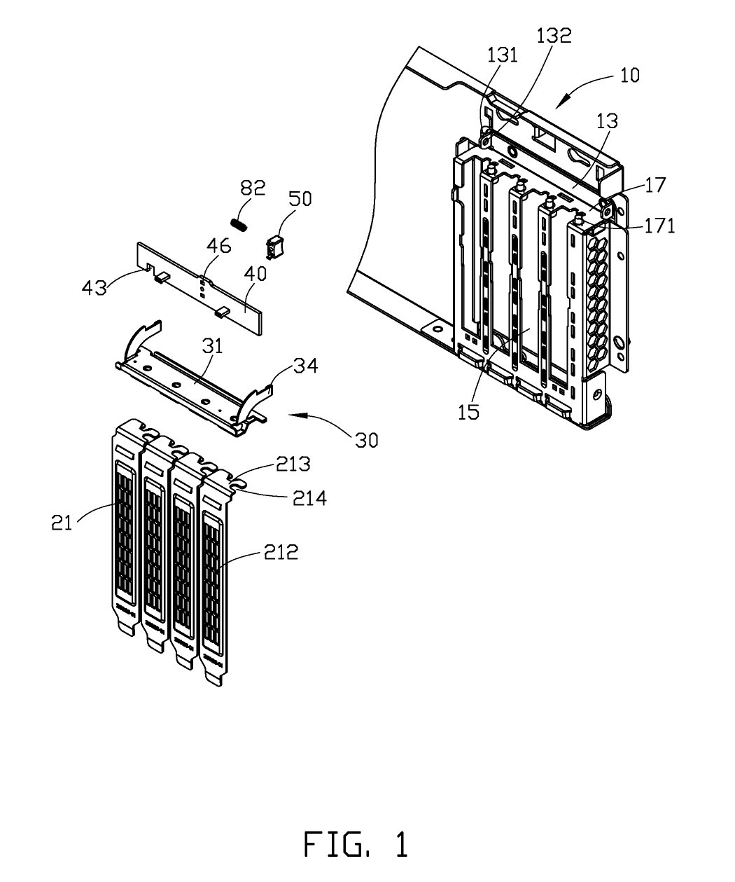

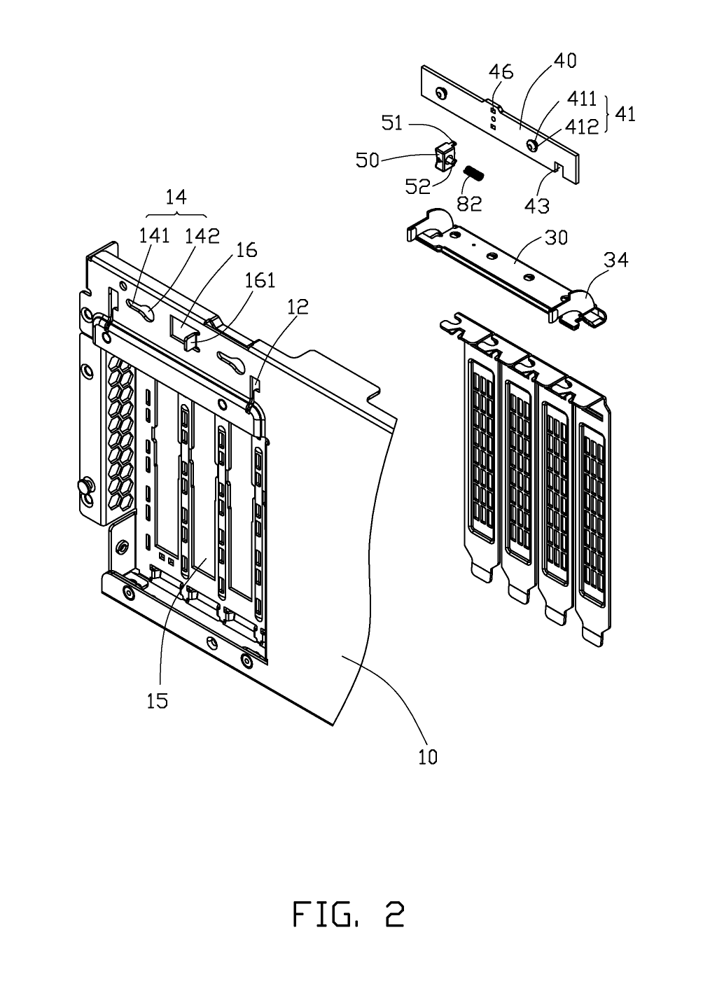

FIGS. 1 and 2 illustrate one embodiment of an expansion card mounting assembly, which includes a pressing member 30, a sliding member 40, a mounting wall 10, and a plurality of expansion cards (not shown). In at least one embodiment, the mounting wall 10 is a wall of a computer chassis.

The mounting wall 10 defines a plurality of expansion slots 15. A support piece 17 is located above the plurality of expansion slots 15. A plurality of positioning pillars 171 corresponding to the expansion slots 15 extends from the support piece 17. In the embodiment, each positioning pillar 171 corresponds to one expansion slot 15. The mounting wall 10 includes a securing plate 13 located above the support piece 17. Opposite edges of the securing plate 13 are bent to form a pair of ear pieces 131. Each ear piece 131 defines a pivot hole 132. The mounting wall 10 defines a pair of receiving slots 12, a pair of sliding slots 14, and an opening 16. The pair of receiving slots 12, the pair of sliding slots 14, and the opening 16 are located above the securing plate 13. The pair of sliding slots 14 is located between the pair of receiving slots 12, and the opening 16 is located between the pair of sliding slots 14. The sliding slot 14 includes a restricting portion 141 and an inserting portion 142 communicating with the restricting portion 141. A blocking piece 161 extends substantially perpendicularly from an edge of the opening 16.

Each expansion card includes a substantially “L”-shaped slot cover 21. The slot cover 21 includes a main body 212 to cover the corresponding expansion slot 15, and a bent portion 213 bent from a top end portion of the main body 212. The bent portion 213 defines a cutout 214.

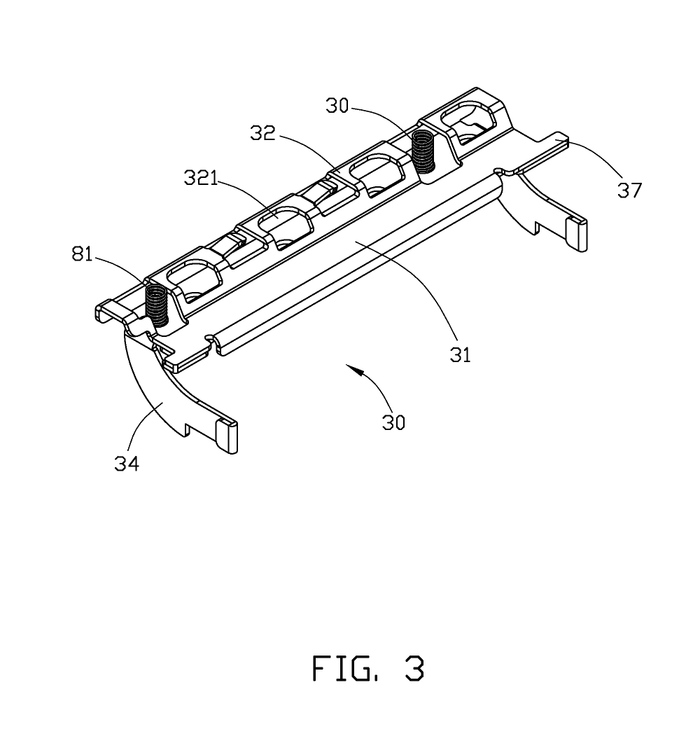

FIG. 3 illustrates that the pressing member 30 includes a pressing board 31. A bent elastic piece 32 is connected to the pressing board 31. Opposite sides of the elastic piece 32 are connected to the pressing board 31, and a substantially central portion of the elastic piece 32 protrudes from the pressing board 31. The elastic piece 32 defines a plurality of holes 321 corresponding to the plurality of positioning pillars 171. Two first springs 81 are mounted on the pressing board 31 and extend through two respective holes 321. A pair of guiding pieces 34 substantially perpendicularly extends from opposite end portions of the pressing board 31. A pair of pivots 37 extends from the opposite end portions of the pressing board 31.

Referring to FIGS. 1 and 2, the sliding member 40 includes two sliding posts 41. Each sliding post 41 includes a pole portion 411 and a head portion 412. The pole portion 411 is connected to the sliding member 40. A size of the head portion 412 is smaller than a size of the inserting portion 142, and larger than a size of the restricting portion 141. A size of the pole portion 411 is smaller than the size of the restricting portion 141. A bottom edge of the sliding member 40 defines an avoiding slot 43. The sliding member 40 defines a plurality of mounting holes 46. A length of the sliding member 40 is smaller than a length of the pressing member 30.

A sliding block 50 can be mounted to the sliding member 40. The sliding block 50 includes a plurality of securing pieces 51 and a securing post 52. A second spring 82 can be sleeved on the securing post 52.

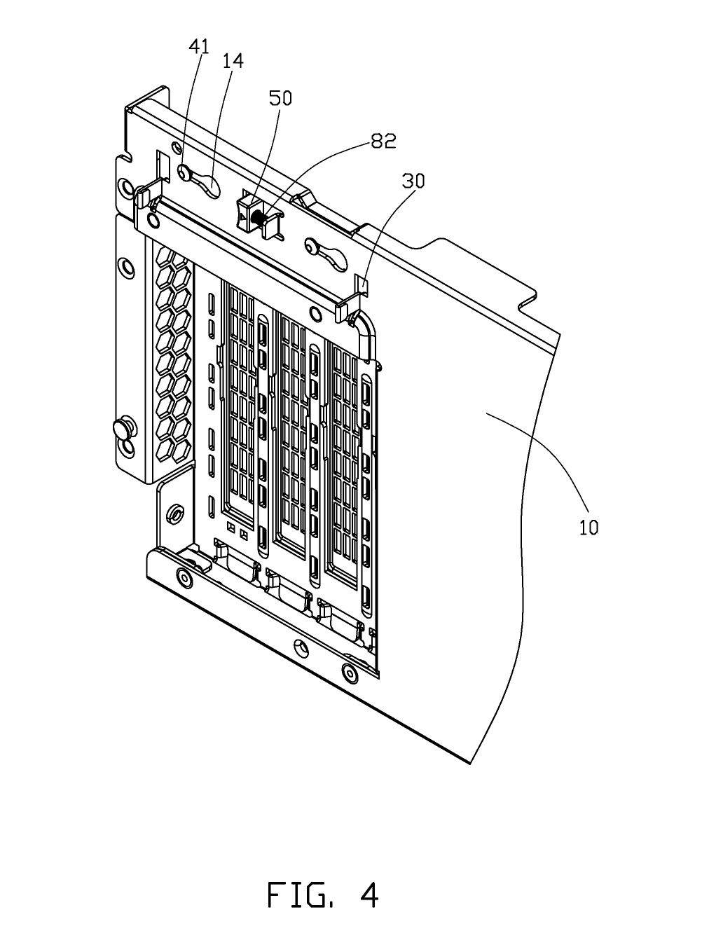

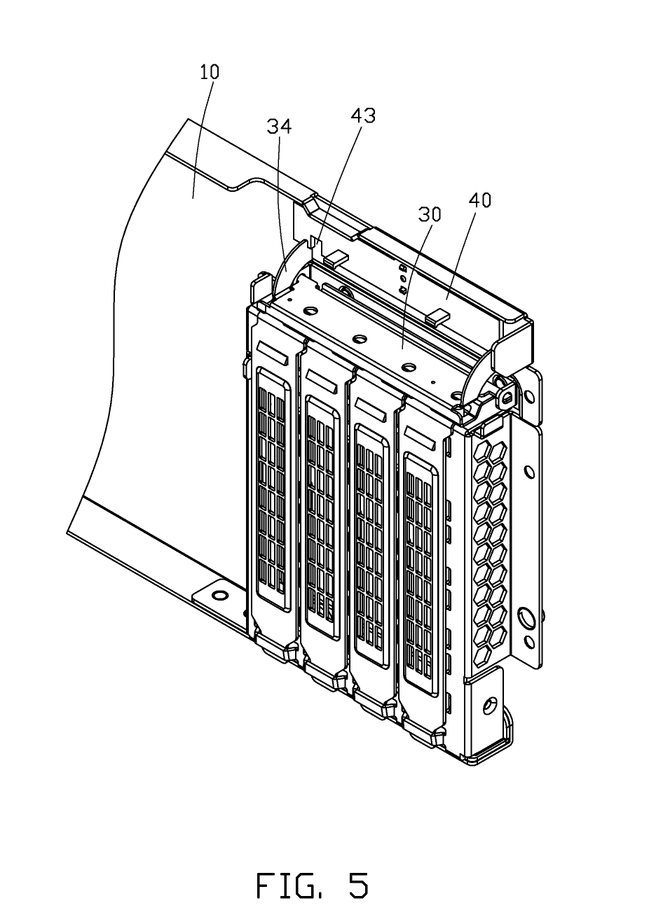

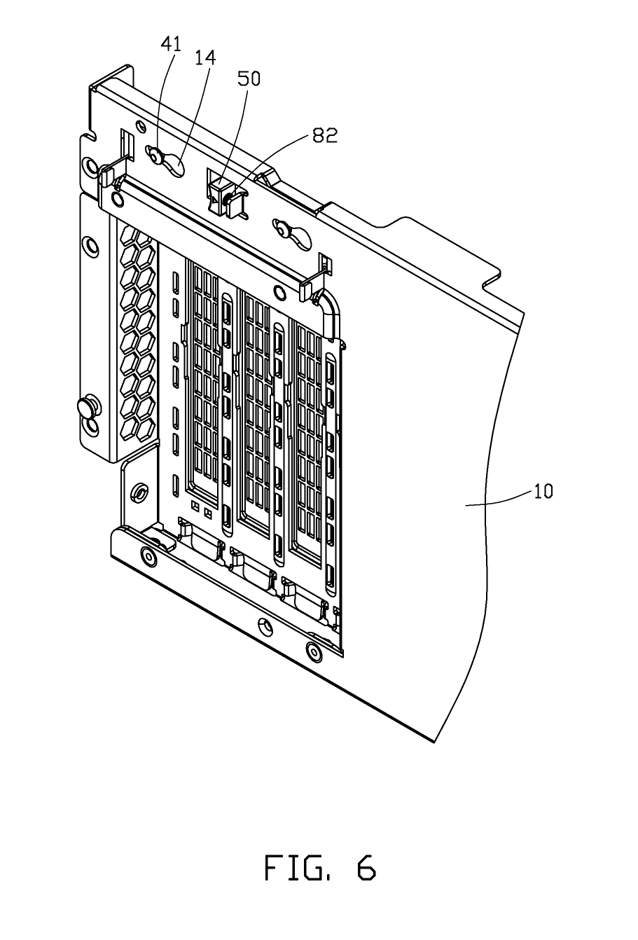

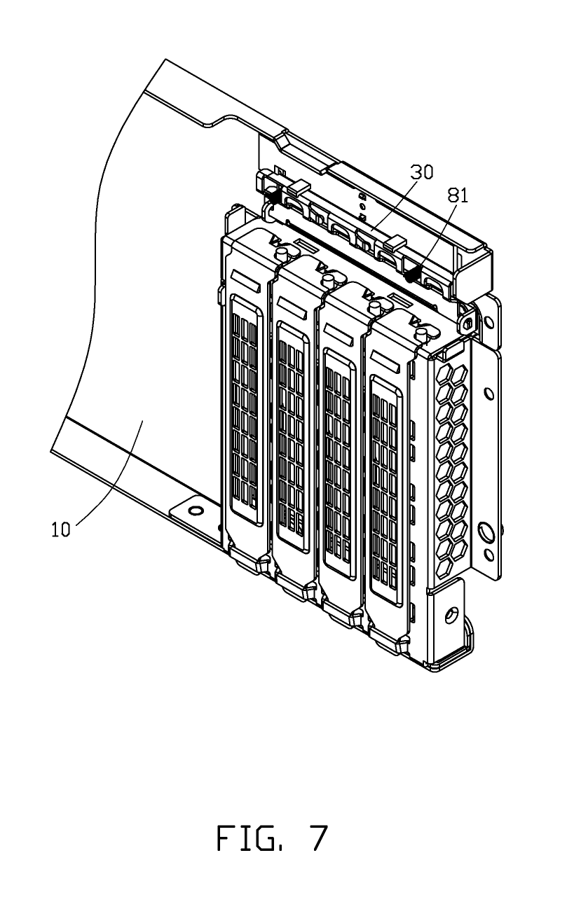

Referring to FIGS. 1-7, in assembly, the securing pieces 51 of the sliding block 50 are mounted in the mounting holes 46 of the sliding member 40. The second spring 82 is sleeved on the securing post 52. The head portions 412 of the sliding posts 41 extend through the corresponding inserting portions 142, such that the pole portions 411 are received in the corresponding inserting portions 142. The sliding block 50 is received in the opening 16. The second spring 82 is elastically compressed by the blocking piece 161. The sliding member 40 is slid along the mounting wall 10, such that the pole portions 411 slide into the corresponding restricting portions 141, and the second spring 82 is released. At this position, the sliding member 40 shields one of the two receiving slots 12, and does not shield the other one of the two receiving slots 12.

The pivots 37 of the pressing member 30 are pivotably mounted in the pivot holes 132 of the mounting wall 10. At this position, the two guiding pieces 34 of the pressing member 30 are aligned to the corresponding two receiving slots 12, and the holes 321 of the pressing member 30 are aligned to the positioning pillars 171 of the mounting wall 10. One of the two guiding pieces 34 is blocked by the sliding member 40.

In use, the sliding block 50 is pushed to slide the sliding member 40 until the avoiding slot 43 is aligned to the corresponding receiving slot 12, thereby compressing the second spring 82. At this position, the sliding member 40 does not shield either of the receiving slots 12. The pressing members 30 are rotated to move the two guiding pieces 34 through the corresponding two receiving slots 12. Then, the slot covers 21 are placed on the mounting wall 10 to cover the expansion slots 15, such that the bent portions 213 are located on the support piece 17. The positioning pillars 171 are inserted through the corresponding cutouts 214 of the bent portions 213. The pressing member 30 is rotated to move the two guiding pieces 34 out of the two receiving slots 12. The elastic piece 32 presses against the bent portion 213, thereby deforming the first springs 81. Then, the second spring 82 is released to move the sliding member 40. The sliding member 40 shields one receiving slot 12 and blocks a corresponding guiding piece 34. Therefore, the pressing member 30 is maintained at the position of pressing the bent portion 213 to secure the slot cover 21 on the mounting wall 10.

To detach the slot cover 21, the sliding block 50 is pushed to slide the sliding member 40 until the avoiding slot 43 is aligned to the corresponding receiving slot 12. The first springs 81 are released to rotate the pressing member 30 to move the two guiding pieces 34 through the two receiving slots 12. Therefore, the slot cover 21 can be detached from the mounting wall 10.

It is to be understood that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. An expansion card mounting assembly, comprising:
a slot cover mounted on an expansion card, the slot cover comprising a bent portion;
a mounting wall defining an expansion slot and a receiving slot, the mounting wall comprising a support piece, wherein the slot cover covers the slot with the bent portion located on the support piece;
a pressing member pivotably mounted on the mounting wall, the pressing member comprising a guiding piece aligned to the receiving slot; and
a sliding member slidably mounted on the mounting wall, wherein the sliding member is configured to move on the mounting wall to shield the receiving slot and block the guiding piece to maintain the pressing member pressing the bent portion, or to be misaligned with the receiving slot to allow the guiding piece to move in the receiving slot to release the bent portion.

2. The expansion card mounting assembly of claim 1, wherein the sliding member comprises an avoiding slot, and the avoiding slot is configured to be misaligned to the receiving slot to have the mounting wall shielding the receiving slot, and is configured to be aligned to the receiving slot to have the mounting wall misaligned to the receiving slot.

3. The expansion card mounting assembly of claim 1, wherein a sliding post is mounted on the sliding member, the mounting wall defines a sliding slot, and the sliding post is configured to slide in the sliding slot when the sliding member slides on the mounting wall.

4. The expansion card mounting assembly of claim 3, wherein the sliding slot comprises an inserting portion and a restricting portion communicating to the inserting portion, the sliding post comprises a pole portion and a head portion, the pole portion is connected to the sliding member, a size of head portion is smaller than a size of the inserting portion and larger than a size of the restricting portion, a size of the pole portion is smaller than the size of the restricting portion, the head portion is inserted through the inserting portion to place the pole portion in the inserting portion, and pole portion is configured to slide between the inserting portion and the restricting portion.

5. The expansion card mounting assembly of claim 1, wherein a sliding block is mounted on the sliding member, the sliding block comprises a spring, the mounting wall comprises a blocking piece, and the spring abuts the blocking piece.

6. The expansion card mounting assembly of claim 5, wherein the mounting wall defines an opening to receive the sliding block, and the blocking piece is connected to an edge of the opening.

7. The expansion card mounting assembly of claim 1, wherein the pressing member comprises a pressing board, opposites ends of an elastic piece is connected to the pressing board, a central portion of the elastic piece is separated from the pressing board and protrudes with respect to the pressing board, and the elastic piece is configured to press the bent portion to be elastically deformed.

8. The expansion card mounting assembly of claim 7, wherein the elastic piece defines a hole, a spring is mounted on the pressing board and extends through the hole, and spring is configured to abut the support piece when elastic piece presses the bent portion.

9. The expansion card mounting assembly of claim 1, wherein the mounting wall comprises a securing plate, the securing plate defines a pair of pivot holes, the pressing member comprises a pair of pivots, and the pair of pivots are pivotably mounted on the pair of pivot holes.

10. An expansion card mounting assembly, comprising:
a mounting wall defining a receiving slot and comprising a support piece, a slot cover comprising a bent portion which is located on the support piece;
a pressing member pivotably mounted on the mounting wall, the pressing member comprising a guiding piece aligned to the receiving slot; and
a sliding member slidably mounted on the mounting wall, the sliding member defining an avoiding slot; wherein the sliding member is configured to move on the mounting wall to misalign the avoiding slot with the receiving slot for shielding the receiving slot and blocking the guiding piece to maintain the pressing member pressing the bent portion, or to align the avoiding slot with the receiving slot to allow the guiding piece to move in the receiving slot to release the bent portion.

11. The expansion card mounting assembly of claim 10, wherein a sliding post is mounted on the sliding member, the mounting wall defines a sliding slot, and the sliding post is configured to slide in the sliding slot when the sliding member slides on the mounting wall.

12. The expansion card mounting assembly of claim 11, wherein the sliding slot comprises an inserting portion and a restricting portion communicating to the inserting portion, the sliding post comprises a pole portion and a head portion, the pole portion is connected to the sliding member, a size of head portion is smaller than a size of the inserting portion and larger than a size of the restricting portion, a size of the pole portion is smaller than the size of the restricting portion, the head portion is inserted through the inserting portion to place the pole portion in the inserting portion, and pole portion is configured to slide between the inserting portion and the restricting portion.

13. The expansion card mounting assembly of claim 10, wherein a sliding block is mounted on the sliding member, the sliding block comprises a spring, the mounting wall comprises a blocking piece, and the spring abuts the blocking piece.

14. The expansion card mounting assembly of claim 13, wherein the mounting wall defines an opening to receive the sliding block, and the blocking piece is connected to an edge of the opening.

15. The expansion card mounting assembly of claim 10, wherein the pressing member comprises a pressing board, opposites ends of an elastic piece is connected to the pressing board, a central portion of the elastic piece is separated from the pressing board and protrudes with respect to the pressing board, and the elastic piece is configured to press the bent portion to be elastically deformed.

16. The expansion card mounting assembly of claim 15, wherein the elastic piece defines a hole, a spring is mounted on the pressing board and extends through the hole, and spring is configured to abut the support piece when elastic piece presses the bent portion.

17. The expansion card mounting assembly of claim 10, wherein the mounting wall comprises a securing plate, the securing plate defines a pair of pivot holes, the pressing member comprises a pair of pivots, and the pair of pivots are pivotably mounted on the pair of pivot holes.
